(19) United States
(12) Patent Application Publication
(10) Pub. No.: US 2003/0038958 A1
(43) Pub. Date: Feb. 27, 2003

(54) Method and apparatus for determining font types to be downloaded to digital printers

(75) Inventors: David L. Salgado, Victor, NY (US); Prakash Goswami, Webster, NY (US); Likang Guo, Rochester, NY (US)

Correspondence Address: Patent Documentation Center, Xerox Corporation, 100 Clinton Ave. S., Xerox Square 20th Floor, Rochester, NY, 14644, US

(73) Assignee: Xerox Corporation.

(21) Appl. No.: 09/939,851

(22) Filed: Aug. 27, 2001

(51) Int. Cl. B41F 1/00; G06F 15/00

(52) U.S. Cl. 358/1.11

(57) ABSTRACT

In a digital printing system, such as including one or more printers connected to a host computer via a network, it is occasionally desired to download software for new fonts to the printers. In many cases, different printers support different “font types” or “font formats,” meaning different encoding methods for the font software. The various printers on the network are queried by remotely querying the MIB associated with each printer, to determine what font type is supported by each printer. When the font software is downloaded, where necessary for a particular printer, the original font software is converted to be supportable by the printer.

### FIELD OF THE INVENTION

The present invention relates to digital printing apparatus, and in particular relates to the downloading of software relating to the creation of fonts to a printer.

### BACKGROUND OF THE INVENTION

Digital printing machines, such as ink-jet printers or “laser printers,” which take data originating at a computer and create images based on the data, are well known. In the case of printing text-based images or documents, the standard model is as follows. The text information of the document is retained in a computer ultimately in a simple alphanumeric format such as ASCII. When it is desired to print the document, the ASCII text is assigned a font, such as Roman, Helvetica, etc., in which it is desired to print the text. The software for causing the printing hardware to create characters of a particular font is typically retained within the printer itself, so that, when it is desired to print text data from a computer, the computer sends to the printer, among other things, an instruction to print the characters at a certain size and in a certain font, as well as code relating to the text to be printed. When the printer receives the instructions and the code, the software within the printer causes the printer to output images of characters in the desired font as needed by the text.

As the software for causing the printer hardware to output characters of a certain font is resident in the printer, occasionally it is necessary to download to the printer the software, as part of a “page description language,” that the printer uses to output the images of characters of a certain font. Such occasions would be the acquisition of a new printer onto a network, or the acquisition of software for a new font. Only after the printer receives this font software (here called the “font package”) can the printer output documents using the font.

A key practical problem with downloading a font package to a printer is that, for many page description languages currently available, there may exist a number of what will here be called “font types,” but which are also known as “font formats.” A font type relates to the way binary data relating to a font is encoded, and by which it should therefore be decoded when the printer is outputting prints. Within each of the two most popular page description languages, there are multiple font types. Adobe® PostScript™, for example, comes in at least two font types, type 2 and type 42. PCL comes in “macro” and “font” types. The encoding system associated with a font type is in effect “fixed” with respect to a particular printer: a printer accepting fonts of, for example, PostScript type 42 will always accept type 42, regardless of new fonts that may come along. The font type is thus a crucial parameter in determining whether a given printer can process a given font. Fonts which are downloaded to a printer must be of a type which the printer is able to accept.

### DESCRIPTION OF THE PRIOR ART

U.S. Pat. Nos. 5,729,666 and 6,252,671 both relate generally to methods for downloading fonts to printers, and taking into account font types.

### SUMMARY OF THE INVENTION

According to one aspect of the present invention, there is provided a method of operating a digital printing apparatus, the digital printing apparatus having a control system associated therewith. The control system is queried to determine a font type supported by the control system. The determined font type is compared to a font type of a font package. If the font type supported by the control system is not compatible with the font package, the font package is converted to the font type supported by the control system. The font package is then downloaded to the control system.

According to another aspect of the present invention, there is provided a method of operating a digital printing apparatus, the digital printing apparatus having a control system associated therewith, comprising the step of reading a portion of a MIB associated with the control system, to determine a font type supported by the control system.

### BRIEF DESCRIPTION OF THE DRAWINGS

FIG. 1 is a simple diagram showing computers and printers on a network.

FIG. 2 is a flowchart illustrating a method according to the present invention.

### DETAILED DESCRIPTION OF THE INVENTION

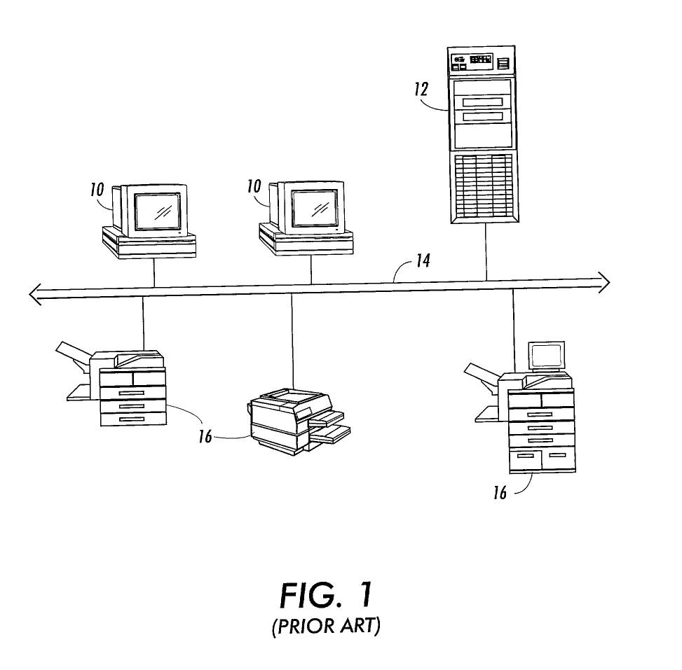

FIG. 1 is a simple diagram showing computers and printers on a network, illustrating a context for the present invention. One of a set of computers such as 10, or a server such as 12 (which is a type of computer) communicate through various means over a network 14 with a selected one of a set of printers 16. (The word “printer” can refer to printer aspects of a multi-function device, such as a copier-printer or copier-printer-fax.) Different types of communication are typically performed in different ways: in order for a computer 10 to query a status of a printer 16, the computer typically uses SNMP calls, while, when the computer is sending document data to be printed, code relating to ASCII characters forming the document text is sent to the printer.

In this networked-printer context, it is a common occurrence to wish to download code relating to a new font to one or many printers. Such a need would occur, for instance, when adding a new printer to the network, or when software for a new font is purchased. In a networked-printer context as illustrated, it is likely that the various printers 16 were each purchased from possibly different manufacturers at different times. It is thus likely that different individual printers are designed to accept different font types, e.g., some printers 16 may require PostScript type 2 while others require type 42. Code, such as stored on a computer 10 or server 12, embodying a font, will be in an original font type at purchase. If a font of a certain font type is desired to be downloaded to a printer which requires another type, the original font code must be converted to the new font type. This conversion step, which is not in itself directly germane to the present invention, is performed by known algorithms.

Most particularly, the present invention relates to a method by which a computer 10 or server 12 determines whether a “target printer” 16 accepts one or another font type, and then converts code related to a font (here called a “font package”) desired to be downloaded as necessary when the code is downloaded to the target printer. According to an embodiment of the present invention, this determination is performed by the SNMP or equivalent calls to query a control MIB (management information base) associated with the target printer: the control MIB of the target printer will include code indicative of the font type required for the printer.

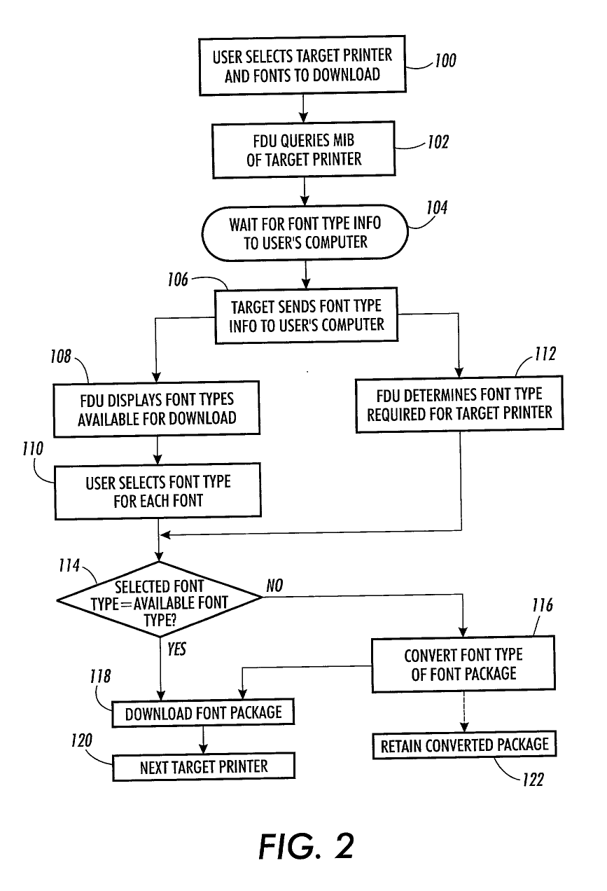

FIG. 2 is a flowchart showing a preferred embodiment of the present invention, from the perspective of a computer 10 or server 12 also on the network 14. First, a user at a computer 10 selects a target printer 16 desired to receive the font code (step 100). A software utility, here called a “font download utility” or FDU, which resides on (or which is otherwise accessible by) computer 10 queries target computer 16, such as with SNMP commands, as to the font type or types the target printer requires (step 102). The computer 10 waits for the response from the target printer (step 104), and then the target computer sends the response to the computer (step 106).

In one embodiment of the present invention, the FDU residing in a computer 10 holding a font package to be downloaded sends a SNMP request to target printer 16, asking for the “Supported-Font-Types” tag in the Fonts Resource MIB of the control system of the printer 16. The “Supported-Font-Types” tag is an extension to the common Resource MIB. The returned information is a list of the font types supported by printer 16. A font type tag has two parts: the PDL section (e.g. PCL, PS, PCL macro) and the type section (e.g. 5, 42).

According to different embodiments of the present invention, the steps of matching code for a desired font type to the requirements of the target printer can be made either manual, or largely invisible to the user of the computer 10. Steps 108 and 110 show a “manual” method, in which the information about the necessary font type is displayed to the user, and the user initiates, through a user interface, matches the font code on his or another computer to the requirements of the target printer. For an invisible method (step 112), the FDU on computer 10, determining the required font type for the target printer, checks the font code and determines whether or not there is a match of font types.

If there is a match between the font type of the font package and the requirements of the target printer (as determined at step 114), the font code is simply downloaded to the target printer through known means (step 118); if there is a mismatch of font types, the FDU initiates a conversion of the font code before it is downloaded (step 116).

The above-described process, with reference to a single target printer, can readily be replicated for a mass download of a plurality of printers on a network. As such, the steps can be re-initiated after finding a new target printer (step 120). Determining which printer on a network will be next to receive the download can be made a function of, for instance, a network discovery process, such as to take into account printers which have been recently added to the network. In such a mass process, it may be desirable to retain a copy of the converted font package (step 122) so the original font package will not have to be repeatedly reconverted as target printers requiring the converted font package are addressed.

1. A method of operating a digital printing apparatus, the digital printing apparatus having a control system associated therewith, comprising the steps of:
querying the control system to determine a font type supported by the control system;
comparing the determined font type to a font type of a font package;
if the font type supported by the control system is not compatible with the font package, converting the font package to the font type supported by the control system; and
downloading the font package to the control system.

2. The method of step 1, the querying step including using a network protocol.

3. The method of step 1, the querying step including reading a portion of a MIB associated with the control system.

4. The method of step 1, further comprising the step of
displaying information related to the font type supported by the control system.

5. The method of step 1, further comprising the step of
retaining data relating to the converted font package.

6. A method of operating a digital printing apparatus, the digital printing apparatus having a control system associated therewith, comprising the step of:
reading a portion of a MIB associated with the control system, to determine a font type supported by the control system.

7. The method of step 6, further comprising the steps of
comparing the determined font type to a font type of a font package;
if the font type supported by the control system is not compatible with the font package, converting the font package to the font type supported by the control system; and
downloading the font package to the control system.

8. The method of step 7, further comprising the step of
retaining data relating to the converted font package.

9. The method of step 6, the reading step including using a network protocol.

10. The method of step 6, further comprising the step of
displaying information related to the font type supported by the control system.
